(19) United States
(12) Patent Application Publication
(10) Pub. No.: US 2019/0271177 A1
(43) Pub. Date: Sep. 5, 2019

(54) Systems and Methods Related to Tethering

(71) Applicant: Stanley A. Johnson, Brookfield, WI (US)

(72) Inventor: Stanley A. Johnson, Brookfield, WI (US)

(21) Appl. No.: 16/418,031

(22) Filed: May 21, 2019

Related U.S. Application Data
(63) Continuation-in-part of application No. 29/691,846, filed on May 20, 2019.

(51) Int. Cl. E05B 73/00

(52) U.S. Cl. CPC E05B 73/0005

(57) ABSTRACT

Systems and methods directed to tethering an object across a spatial interface include an orb linked to an anchor. The orb may be substantially spherical, further including a plurality of voids separated by at least one lobe. The orb is linked to the anchor, such as by a cable or rope, tensilely secured to each. The tensile securement of the link to the orb and/or anchor may be fixed or movable. An anchor is provided as a toggle extending longitudinally perpendicular to the general longitudinal direction of the link. A method includes the steps of securing the anchor to a receptacle in a first space, allowing or causing the link to cross a structural interface, and disposing the orb in a second space, thereby tethering the receptacle relative to the structural interface.

### RELATED APPLICATIONS

This application is a continuation-in-part of co-pending U.S. design patent application Ser. No. 29/691,846, filed 20 May 2019, and titled “Tether Anchor,” which is incorporated by reference herein in its entirety.

### BACKGROUND OF THE INVENTION

The present invention relates generally to tangible property container systems and more particularly to advantageous improvements in delivery receptacles and tether anchors.

Security as against removal or theft of tangible property has been important since the origin of the concept of property, itself. Understanding such importance, several legal principles have been created to deter would-be thieves, such as trespass, trespass to chattels, civil theft, criminal theft, and conversion. Unfortunately, while some of these actions remain available for a private citizen to recover property or the value thereof (if the thief is known), an activity known as porch pirating has become prevalent despite the existence of present laws.

Porch pirating has become prevalent as the popularity of receiving products via courier has increased. Persons often receive products that have been ordered remotely, such as over the telephone or through an interface provided over a network, such as the internet. Online ordering and subscription-based delivery services has exploded in popularity, but with such explosion, security weaknesses have been unfortunately uncovered and exploited.

While certain deliveries are protected by federal law (e.g., deliveries made by the U.S. postal service to a U.S. mail box), couriered deliveries are often left exposed to relatively easy access, even if such access requires trespass onto real property. Opportunistic porch pirates have been known to lie in wait in residential neighborhoods while residents may be away from their homes, such as at work or traveling. Nevertheless, such residents may be expecting or requiring deliveries during such times of absence or other unavailability. Courier delivery trucks are noticed, and delivery locations are witnessed. Once the delivery truck has left the area, it is quite simple for a porch pirate to dash onto a

Accordingly, the art of tangible property security would benefit from systems and methods that address one or more of the drawbacks of prior systems.

### SUMMARY OF THE INVENTION

According to aspects of a tether according to the present invention includes a first end defined by an orb, and a second end defined by an anchor, the anchor being different than the orb. The orb and the anchor are secured by a longitudinal link extending between them. The anchor preferably includes a toggle or a lariat. On one end, the longitudinal link may be secured to or form at least a part of the anchor. On the other end, the link is may be movably or immovably secured to the orb. A ferrule may be secured to the link and received against or within the orb. The ferrule may be received within a ferrule receptacle formed into the outer surface of the orb. A link throughbore having a greater diameter than the link may extend through a diameter of the orb and may intersect the ferrule receptacle. When assembled, the link preferably extends into the orb at least substantially parallel to, and more preferably coaxially with, a link axis that is disposed along a diameter of the orb. A preferred orb includes a plurality of partially cylindrical voids separated by at least one radially extending lobe. The voids may be formed by removing material from a sphere of material or substantially contemporaneously with the remainder of the orb, such as by being molded.

According to an aspect of a tether according to the present invention, a latch plate may be provided to cooperate with the link and/or anchor. The latch plate may be removably securable to the link and anchor, such as including a slot configured to receive the link and a preferably concave toggle surface to receive the toggle.

A method according to the present invention includes providing a tether extending between two terminus structures. A first of the two terminus structures is inserted through an aperture formed in a container, which is located in or placed in a first physical space. The second terminus structure is placed in a second physical space. The first and second spaces are at least partially separated by a movable structure, such as a door.

According to an aspect of a method according to the present invention, human access to the second space (e.g., a room, building, or automobile, or portion thereof, which may be locked) may be more restrictive than human access to the first space (e.g., outdoors or a different room, building, or automobile, or portion thereof).

### BRIEF DESCRIPTION OF THE DRAWINGS

FIG. 1 is a perspective view of a first embodiment of a tether according to the present invention, including alternative termination ends.

FIG. 2 is a perspective view of a first security orb according to the present invention.

FIG. 3 is a perspective view of a first assembly step according to the present invention.

FIG. 4A is a front elevation view of the embodiment of FIG. 1.

FIG. 4B is a partial right side elevation view of the embodiment of FIG. 4A, to which the left side elevation view, top plan view, and bottom plan view are identical.

FIG. 4C is a cross-section view taken along line 4C-4C of FIG. 4B.

FIG. 5 is a perspective view of a second assembly step according to the present invention.

FIG. 6 is a perspective view of a third assembly step according to the present invention.

FIG. 7 is a perspective view of a fourth assembly step according to the present invention.

FIG. 8 is perspective view of a first use case according to the present invention.

FIG. 9 is a partial cross-section elevation view taken along line 9-9 of FIG. 8.

FIG. 10 is a top plan view taken in the direction of arrow 10 of FIG. 8.

FIG. 11 is a perspective view of a second use case according to the present invention.

FIG. 12A is a front elevation view of a second embodiment of a security orb according to the present invention, to which the rear elevation view is identical.

FIG. 12B is a right side elevation view of the embodiment of FIG. 12A, to which the left side elevation view is identical.

FIG. 12C is a top plan view of the embodiment of FIG. 12A.

FIG. 13A is a front elevation view of a fourth embodiment of a security orb according to the present invention.

FIG. 13B is a right side elevation view of the embodiment of FIG. 13A, to which the left side elevation view is identical.

FIG. 13C is a top plan view of the embodiment of FIG. 13A.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

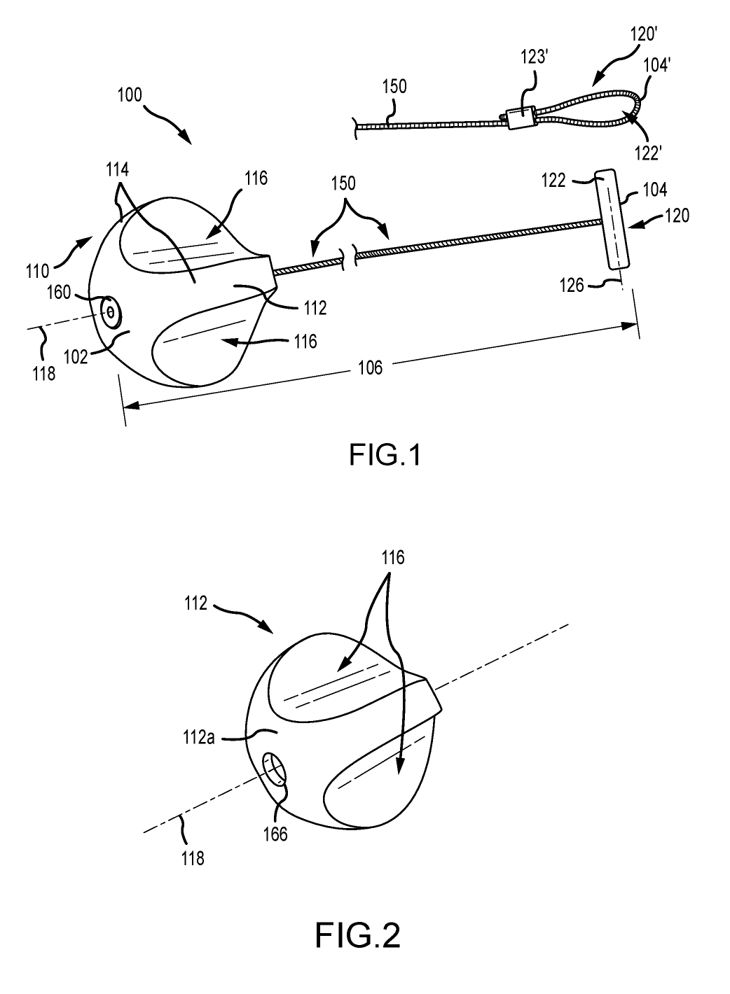

Turning to FIG. 1, a first embodiment 100 of a tether according to the present invention is shown extending from a first end 102 to a second end 104, along a tether length 106. A first end terminus structure 110 is provided at and defines the first end 102. A preferred first end terminus structure 110 is a security orb 112. A second end terminus structure 120 is provided at and defines the second end 104. A preferred second end terminus structure 120 is a toggle 122.

Extending along a majority of the tether length 106 is an anchor link 150. The tether length 106 is defined as the overall measurement of the tether 100 from the first end 102 to the second end 104 while the link 150 is tensioned sufficiently to at least substantially straighten it. A preferred link 150 comprises or consists essentially of 1/16″ braided steel cable (e.g., 7×19 aircraft cable), which may be stainless steel. Other link materials may include or consist of nylon rope, nylon coated polyester, or copper. The link may be treated or coated with one or more materials (e.g., with vinyl or polytetrafluoroethylene (PTFE)) to enhance wear properties and/or shear strength. An alternative terminus structure 120′ at the second end 104′ may be provided as a loop or lariat 122′, which is preferably constructed as an extension of the link 150, such as by being looped and passed through and secured (e.g., crimped) by a loop ferrule 123′.

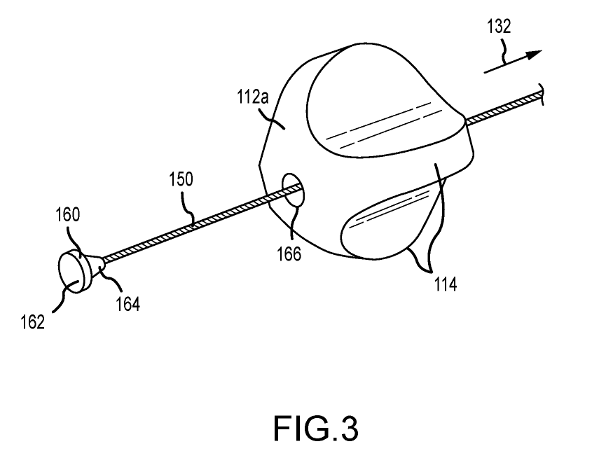

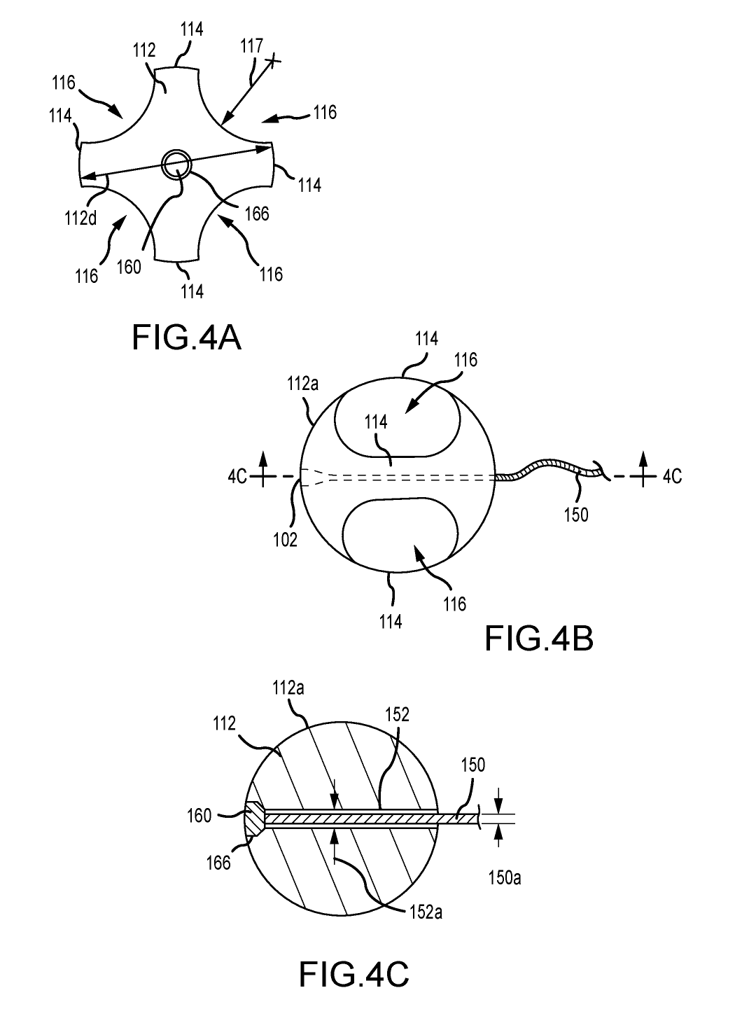

Referring also to FIGS. 2-4C, a preferred orb 112 according to the present invention preferably has a plurality of lobes 114 extending radially outwardly. The lobes 114 are preferably formed by a plurality of partially cylindrical voids 116, which may extend at least substantially parallel to each other. The orb 112 generally has an outer surface 112a that extends within a substantially spherical boundary defined by the lobes 114. A diameter 112d of the orb 112 extends along a longitudinal link axis 118 which preferably intersects a point along the outer surface 112a at which the link 150 exits and/or enters the orb 112.

In this first embodiment 100, the link 150 is tensilely secured (e.g., when pulled in a direction 132 of the toggle 122) relative to the orb 112 by the use of a ferrule 160. The ferrule 160 has a distal surface 162 that is substantially flat or approximates the contour of the outer surface 112a of the orb 112. The ferrule 160 has a proximate surface 164, which is preferably frustoconical in shape and is adapted to be received within a ferrule receptacle 166 formed through the outer surface 112a of the orb 112. The interior of the receptacle 166 is shaped to receive the ferrule 160, and when fully inserted, the distal surface 162 is intended to and preferably does substantially align with the outer surface 112a of the orb 112. The ferrule 160 is secured to the link 150, such as by swaging, welding, injection molding, potting, or adhering. Most preferably, the link 150 is prevented from extending distally beyond the ferrule distal surface 162, thereby providing a relatively smooth surface 162.

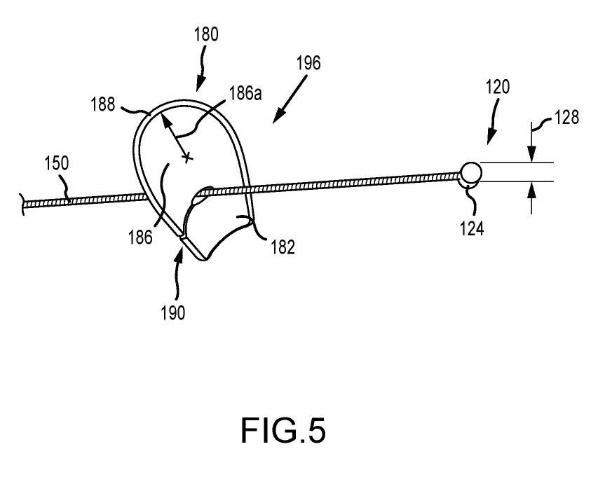

A preferred toggle 122 is a cylindrical rod 124 (e.g., steel, plastic, or wood), though other longitudinal shapes are contemplated, which is secured to the link 150, such as by swaging, welding, injection molding, potting, or adhering. The link 150 extends from an outer cylindrical wall of the rod 124, such that a toggle axis 126 is disposed preferably at least substantially perpendicular to the link axis 118 when the link 150 is in tension between the orb 112 and toggle 122. As best seen in FIG. 5, if the toggle 122 is provided as a rod 124, such rod 124 has a toggle diameter 128 disposed perpendicular to the toggle axis 126 and a toggle length 129 disposed parallel to the toggle axis 126.

To form a preferred orb 112, it is preferably formed from a unitary piece of material, such as plastic, vulcanized rubber, metal (e.g., aluminum), or wood. Thus, the lobes 114 may be formed simultaneously with the remainder of the orb 112 (e.g., during a molding process) or the lobes 114 may be formed after a substantially spherical body is molded or otherwise constructed, and the voids 116 are then removed by machining, drilling, etc. Alternatively, the entire orb 112 may be systematically milled from a blank workpiece, such as a block or other piece of plastic, metal, or wood. A link throughbore 152, extending entirely through the orb 112 along the link axis 118 (and preferably substantially coaxially with and intersecting the ferrule receptacle 166) may be formed during or after molding, but is preferably drilled. The link throughbore 152 has a diameter 152a that is preferably greater than a diameter 150a of the link 150, so as to allow the link 150 to slide easily within the throughbore 152. To assemble the link 150 with the orb 112 and toggle 122, the link 150 is inserted through the link throughbore 152, and the ferrule 160 and toggle 122 are secured thereto. Either the toggle 122 or the ferrule 160, or neither, may be secured to one end of the link 150 prior to the link 150 being inserted through the link throughbore 152. Then, once the link 150 is disposed in such throughbore 152, the other of the ferrule 160 or the toggle 122 can be secured to the other end of the link 150. If neither the toggle 122 or the ferrule 160 is secured to the link 150 prior to insertion through the throughbore 152, then both are secured to opposite ends of the link 150 thereafter.

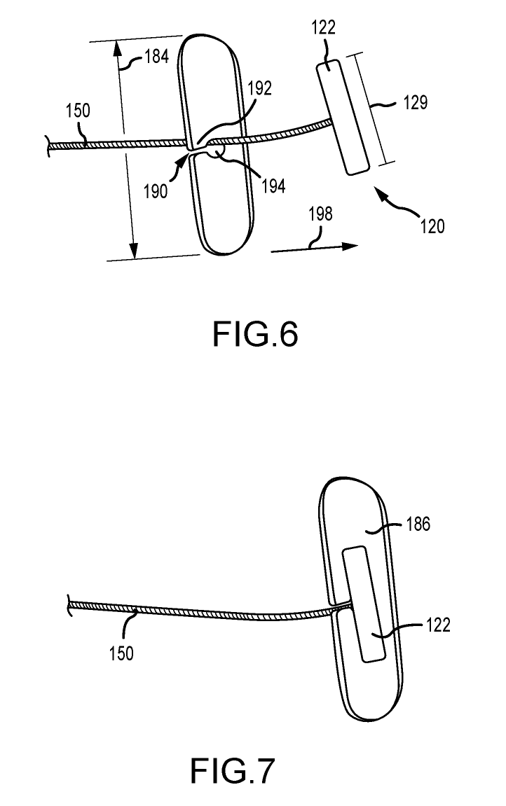

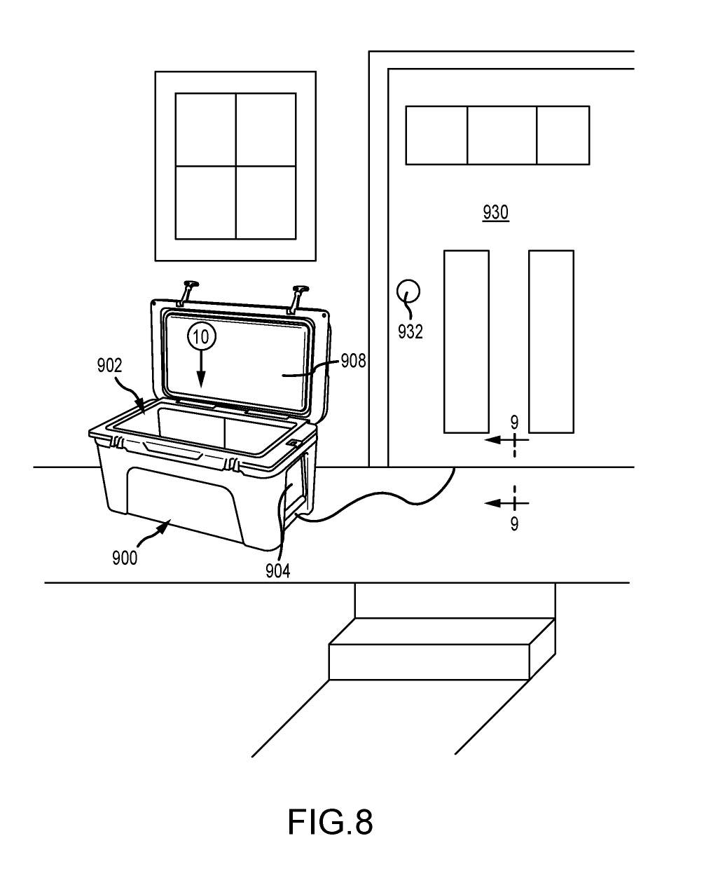

As shown in FIGS. 5-7, optionally provided to cooperate with the toggle 122 is a latch plate 180. The latch plate 180 may be desirable in combination with certain receptacles (such as receptacle 900 in FIG. 8) to more evenly spread out an application of force by pulling on the link 150 in a direction away from the receptacle. Various shapes of latch plates 180 are contemplated, such as disk or ring, but a preferred latch plate 180 is provided as a partially cylindrical plate 182 having a length 184 along which a concave toggle surface 186 (formed along a radius 186a) and opposite convex contact surface 188 extend. Formed into the latch plate 180 is a keyway slot 190, adapted to receive and retain the link 150. The slot 190 has a neck slot 192 leading to a head void 194. The neck slot 192 is preferably of sufficient width to receive and allow passage (though it may be frictional passage) of the link 150 when the link 150 is aligned with the slot 192 and the plate 180 is pushed in an engagement direction 196, thereby eventually depositing the link 150 into and extending through the head void 194. The plate 180 may then be moved along the link 150 in a toggle direction 198 to allow the toggle 122 to come to rest against the concave toggle surface 186 of the latch plate 180 as best shown in FIG. 7. The diameter 128 of the toggle rod 124 is preferably substantially smaller than twice the radius 186a of the concave toggle surface 186 of the latch plate 180. A preferred size differential is a diameter 128 of about 0.25 inches and a radius 186a of about 0.375 inches. Thus the diameter 128 measurement is equal to about ⅓ of a measurement that is twice the radius 186a. It has been discovered that this size differential helps to minimize rotation of the latch plate 180 about the toggle rod 124. Alternatively, a latch plate may be provided with a serpentine slot or a plurality of substantially parallel slots to receive the link 150 extending through the plate at a plurality of locations.

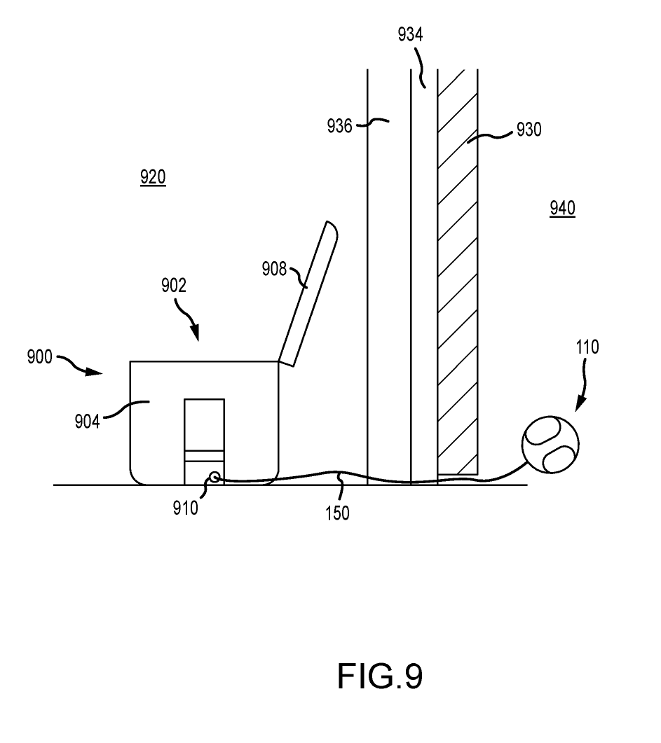

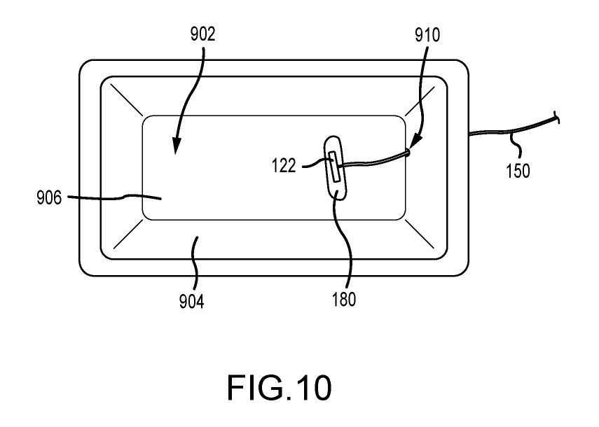

To use a tether according to the present invention, and referring now to FIGS. 8 and 9, a container or receptacle 900 is provided, the container 900 having an internal compartment 902. Through a portion of the container 900, such as a sidewall 904, a bottom 906, a top 908, a toggle aperture 910 is formed. The aperture 910 may be drilled, for example, having a diameter that is preferably at least as large as the toggle diameter 128 plus the link diameter 150a, but more preferably about as large as the toggle diameter 128 plus twice the link diameter 150a, and preferably less than one-half the toggle length 129. Where a latch plate 180 is used, the aperture 910 is still preferably at least as large as the toggle diameter 128 plus the link diameter 150a, but more preferably about as large as the toggle diameter 128 plus twice the link diameter 150a, and preferably less than one-half the latch plate length 184. The toggle 122 is inserted through the toggle aperture 910, preferably by substantially aligning the toggle axis 126 with the longitudinal direction of the link 150 and then pushing a portion of the link 150 through, and the toggle 122 completely through, the aperture 910. Thus, when the link 150 is tensioned away from the receptacle 900, the toggle 122 is forced against an inner wall of the cavity 902. If a latch plate 180 is to be used, the latch plate 180 may be disposed about the link 150 (such as manually, preferably without the use of tools) after the toggle 122 has been inserted into the receptacle cavity 902 through the aperture 910.

In addition to coupling the second end 104 of the tether 100 to a container 900 or other object to be secured, the first end 102 or orb 110 of the tether 100 may be arranged so as not to be extractable with reasonable force (e.g., preferably less than 500 pounds) applied longitudinally to the link 150 in a direction towards the toggle 122. That is, the container 900 may be placed in a first space 920, and the orb 112 may be positioned in a second space 940, the first space 920 being preferably at least partially physically separated from the second space 940 by a moveable structure, such as a door 930. While the second space 940 could be the same general physical space (e.g., room, outdoors, delivery truck cargo space, etc.) as the first space 920, such as if the toggle 122 were first inserted through a secure structure (e.g., a table or heavy (e.g., greater than 50 pounds, but more preferably greater than 100 pounds) anchor, or fixed anchor) and then into the receptacle 900, the second space 940 is more preferably more secure from human access than the first space 920. For instance, the door 930 may have a keyed or combination lock 932 to prevent normal door opening operation in the absence of use of the respective key or combination. Thus, the door 930 may be maintained in a closed position against a portion of a door jamb 934 which may be secured to a wall 936. The link 150 is allowed to extend under or around or through the space-dividing structure (e.g., door 930) thereby securing the receptacle 900 relative to the structure 930. Thus, the tether 100 is selectively placeable and securable, preferably manually (i.e., without tools) to secure a container 900 that is accessible in a less secure space 920 by securing the orb 112 in a more secure space 940. Any longitudinal force exerted on the link 150 in an attempt to remove the container 900 from the less secure space 920 will result in the orb 112 being jammed against and restricted by the door 930 or other structure. Most preferably, the container 900 is configured to be secured closed, such as by combination lock or padlock, once property is placed in the cavity or compartment 902, thus restricting access to the toggle 122.

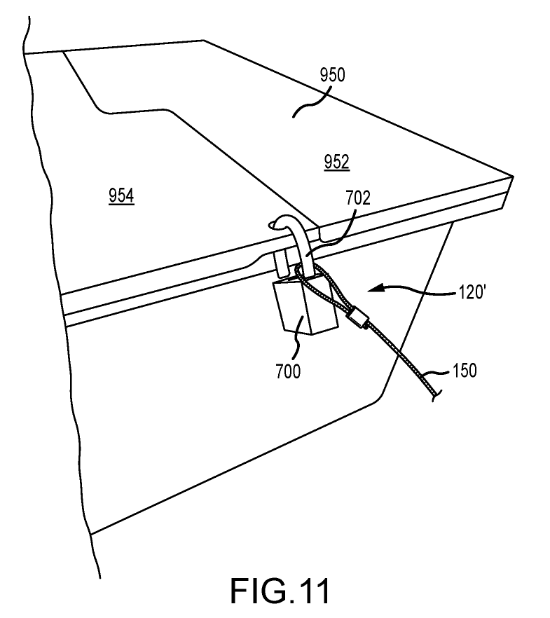

FIG. 11 depicts the alternate embodiment 120′ (from FIG. 1) of a terminus structure disposed on an opposite end of the link 150 from the orb 112, in use and extending around a shank 702 of an open padlock 700. Once locked, the padlock 700 may secure together a portion of opposing hinged lid members 952,954 of a conventional attached lid container 950, as is commonly used in inventory maintenance and shipping. Thus, in this embodiment, the alternate terminus structure 120′ is accessible outside of the container 950.

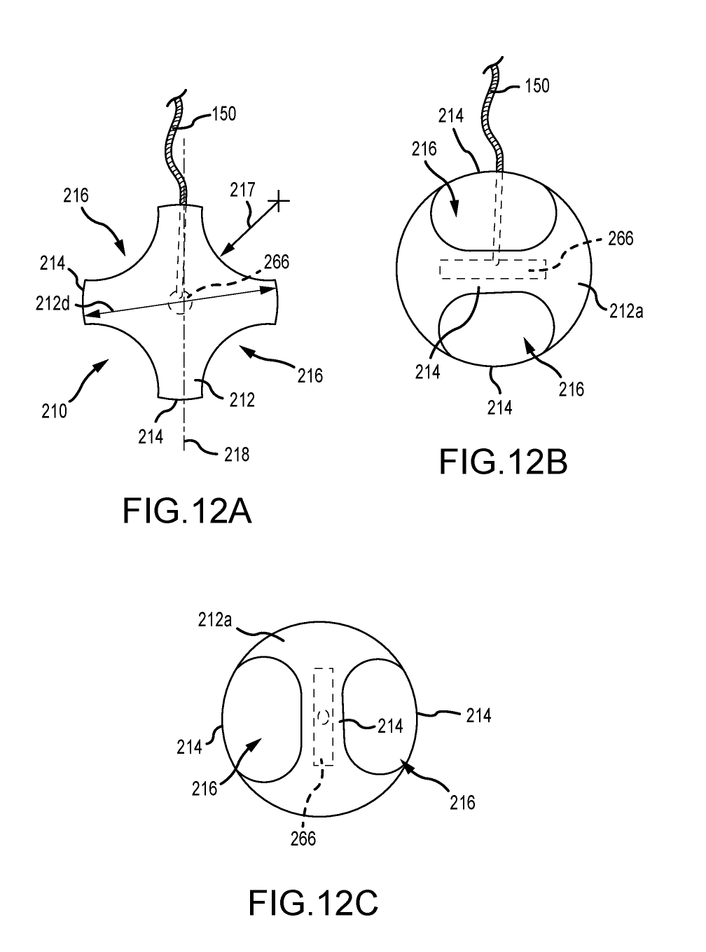

FIGS. 12A-12C show an alternative embodiment 210 of an orb 212 according to the present invention, where like numbering refers to substantially similar or identical structure to the first embodiment 112, unless otherwise noted herein. In this embodiment, the link 150 extends into the orb 212, and is anchored within the orb 212 by utilizing a ferrule or end pot 266 that is encapsulated within the orb 212. To make this embodiment, the ferrule or end pot 266 is secured to the link 150, such as by swaging, welding, injection molding, potting, or adhering. Then, it 266 (along with a portion of the link 150) is placed in a mold (not shown) to be filled with a molding material, such as plastic or metal, to form the orb 212. It should be noted that in this embodiment, as with the other embodiments, the link axis 218 may extend at some angle (even substantially perpendicular to) the general running direction of the voids 216 that form the lobes 214.

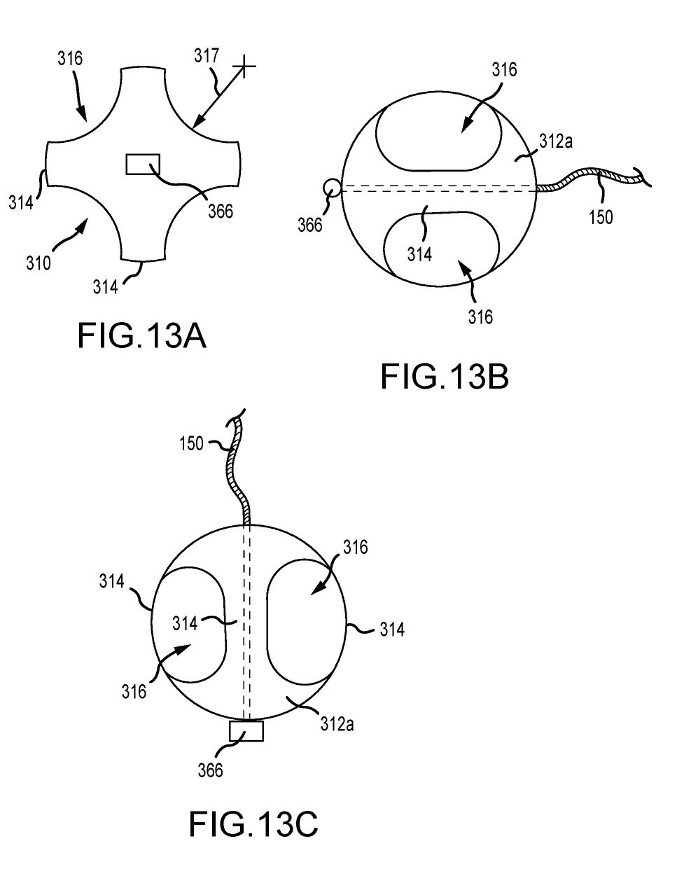

FIGS. 13A-13C show another alternative embodiment 310 of an orb 312 according to the present invention, where like numbering refers to substantially similar or identical structure to the first embodiment 112, unless otherwise noted herein. In this embodiment, the link 150 may be molded into or inserted through the orb 312, and terminated in a second toggle 366. The second toggle 366 is secured to the link 150, such as by swaging, welding, injection molding, potting, or adhering, which can be performed prior to or after insertion of the link 150 through the orb 312. The second toggle 366 may be identical to or different from the first toggle 122.

The foregoing is considered as illustrative only of the principles of the invention. Furthermore, since numerous modifications and changes will readily occur to those skilled in the art, it is not desired to limit the invention to the exact construction and operation shown and described. For instance, while terms like “top” and “bottom” are used throughout, the terms are intended for general reference. Though technically such terms may include precise top (vertically above) and bottom (vertically below) directionality, such precision is not required to fall within the scope of the description. While the preferred embodiment has been described, the details may be changed without departing from the invention, which is defined by the claims.

What is claimed is:

1. A tether comprising:
a first end defined by an orb;
a second end defined by an anchor, the anchor being different than the orb; and
a longitudinal link secured between the orb and the anchor.

2. The tether according to claim 1, wherein the anchor is a toggle.

3. The tether according to claim 2, wherein a first end of the longitudinal link is secured to a ferrule and a second end of the longitudinal link is secured to the toggle.

4. The tether according to claim 3, further comprising:
a ferrule receptacle formed into an outer surface of the orb; and
a link throughbore extending from the ferrule receptacle through a diameter of the orb,
wherein the ferrule is received within the ferrule receptacle and the link extends through the link throughbore.

5. The tether according to claim 4, wherein a diameter of the link throughbore is greater than a diameter of the link.

6. The tether according to claim 1, wherein the anchor is a lariat.

7. The tether according to claim 1, further comprising:
a link axis disposed along a diameter of the orb,
wherein the link extends into the orb at least substantially parallel to the link axis.

8. The tether according to claim 7, wherein the link extends into the orb at least substantially coaxial with the link axis.

9. The tether according to claim 1, wherein the orb comprises a plurality of partially cylindrical voids separated by at least one radially extending lobe.

10. The tether according to claim 9, wherein the plurality of cylindrical voids is formed by removing material from a sphere of material.

11. The tether according to claim 9, wherein the plurality of partially cylindrical voids and at least one radially extending lobe are formed at least substantially contemporaneously.

12. The tether according to claim 1, further comprising a latch plate removably securable to the link and anchor.

13. The tether according to claim 12, wherein the latch plate comprises a slot configured to allow passage of the link therethrough.

14. The tether according to claim 12, wherein the anchor comprises a cylindrical rod, and the latch plate comprises a concave toggle surface having a greater radius than a radius of the cylindrical rod.

15. A method comprising the steps of:
providing a tether extending between two terminus structures;
inserting a first of the two terminus structures through an aperture formed in a container;
placing the container in a first space; and
placing the second terminus structure in a second space,
wherein the first space and the second space are separated by a movable structure.

16. The method according to claim 15, wherein human access to the second space is more restrictive than human access to the first space.

17. The method according to claim 15, the movable structure comprising a door.

18. The method according to claim 17, the door comprising a hinged door.

19. The method according to claim 17, the door comprising a lock.
